(19) United States
(12) Patent Application Publication
(10) Pub. No.: US 2024/0112441 A1
(43) Pub. Date: Apr. 4, 2024

(54) IMAGE PROCESSING APPARATUS, TRAINING APPARATUS, METHOD, AND NON-TRANSITORY COMPUTER READABLE STORAGE MEDIUM

(71) Applicant: CANON KABUSHIKI KAISHA, Tokyo (JP)

(72) Inventors: Kosuke SAITO, Tokyo (JP); Shunta TATE, Tokyo (JP)

(21) Appl. No.: 18/451,152

(22) Filed: Aug. 17, 2023

(30) Foreign Application Priority Data
Sep. 26, 2022 (JP) 2022-152804

(51) Int. Cl. G06V 10/75; G06V 10/74; G06V 10/82; G06V 40/16

(52) U.S. Cl. CPC G06V 10/751; G06V 10/761; G06V 10/82; G06V 40/168; G06V 40/172

(57) ABSTRACT

There is provided with an image processing apparatus. An extraction unit extracts a first feature from first data of a first modal type, the first data including information of a first object that is registered, and extract a second feature from second data of a second modal type that is different from the first modal type, the second data including information of a second object for matching. A determination unit determines whether or not the first object and the second object are identical, based on the first feature and the second feature. The extraction unit is trained to extract the first feature and the second feature to be similar when the first object and the second object are identical.

### BACKGROUND OF THE INVENTION

### Field of the Invention

The present invention relates to an image processing apparatus, a training apparatus, a method, and a non-transitory computer readable storage medium.

### Description of the Related Art

A face authentication system may include an image processing apparatus configured to compare a preliminarily registered face image with a face image for matching, and determine whether or not the face captured in the registered face image is identical to the face captured in the face image for matching. Specifically, the image processing apparatus performs face authentication by acquiring feature amounts from both the registered face image and the face image for matching using a same feature amount conversion unit, and comparing the feature amounts. However, the image processing apparatus may sometimes fail to perform face authentication when the face image for matching is an RGB image, which may be affected by illumination conditions at image capturing, difference in facial expression, face orientation, or the like. As a solution to the aforementioned problem, there is a method that performs face authentication using a face image for matching other than an RGB image. For example, the image processing apparatus can perform matching between a face image for registration and a face image for matching with a higher accuracy by using three-dimensional face shape data. Here, generation of three-dimensional face shape data requires a dedicated device, which raises a problem of introduction cost. Therefore, face authentication for a case where either the face data for registration or the face data for matching is not three-dimensional face shape data has been proposed (Japanese Patent Laid-Open No. 2015-162012).

For example, a two-dimensional image is used as the face data for registration, and a combination of a monochrome image and depth information, which is also referred to as 2.5-dimensional data, is used as the face data for matching (Japanese Patent Laid-Open No. 2015-162012.) The two-dimensional face data and the 2.5-dimensional face data are respectively converted into three-dimensional face shape data, which are then matched with each other, taking into account the difference between images of different modal types (Japanese Patent Laid-Open No. 2015-162012.) Here, images of mutually different modal types refer to images with different physical quantities and qualities of information on which the images are based.

### SUMMARY OF THE INVENTION

According to the present invention, it is possible to provide a technique for improving the authentication accuracy of an object when the authentication of the object using registered data and data for matching having different modal types from each other is performed.

The present invention in its aspect provides an image processing apparatus comprising at least one processor, and at least one memory coupled to the at least one processor, the memory storing instructions that, when executed by the processor, cause the processor to act as an extraction unit configured to extract a first feature from first data of a first modal type, the first data including information of a first object that is registered, and extract a second feature from second data of a second modal type that is different from the first modal type, the second data including information of a second object for matching, and a determination unit configured to determine whether or not the first object and the second object are identical, based on the first feature and the second feature, wherein, the extraction unit is trained to extract the first feature and the second feature to be similar when the first object and the second object are identical.

The present invention in its aspect provides a training apparatus comprising at least one processor, and at least one memory coupled to the at least one processor, the memory storing instructions that, when executed by the processor, cause the processor to act as an extraction unit configured to extract a third feature from third data of a third modal type, the third data including information of a third object, and extract a fourth feature from fourth data of a fourth modal type that is different from the third modal type, the fourth data including information of a fourth object, and an update unit configured to update a third parameter corresponding to the third modal type and a fourth parameter corresponding to the fourth modal type, based on the third feature and the fourth feature, respectively, wherein the update unit updates each of the third parameter and the fourth parameter making the third feature and the fourth feature to be similar when the third object and the fourth object are identical.

The present invention in its aspect provides a method comprising extracting a first feature from first data of a first modal type, the first data including information of a first object that is registered, and extract a second feature from second data of a second modal type that is different from the first modal type, the second data including information of a second object for matching, and determining whether or not the first object and the second object are identical, based on the first feature and the second feature, wherein, a neural network used in the extracting is trained to extract the first feature and the second feature to be similar when the first object and the second object are identical.

The present invention in its aspect provides a non-transitory computer-readable storage medium storing instructions that, when executed by a computer, cause the computer to perform a method comprising extracting a first feature from first data of a first modal type, the first data including information of a first object that is registered, and extract a second feature from second data of a second modal type that is different from the first modal type, the second data including information of a second object for matching, and determining whether or not the first object and the second object are identical, based on the first feature and the second feature, wherein, a neural network used in the extracting is trained to extract the first feature and the second feature to be similar when the first object and the second object are identical.

Further features of the present invention will become apparent from the following description of exemplary embodiments (with reference to the attached drawings).

### BRIEF DESCRIPTION OF THE DRAWINGS

FIG. 1 is a diagram illustrating an example of a hardware configuration of an image processing apparatus;

FIG. 2 is a block diagram illustrating an example of a functional configuration according to a first embodiment;

FIG. 3A is a diagram illustrating conventional matching processing;

FIG. 3B is a diagram illustrating a matching processing of the present invention;

FIG. 4 is a flowchart illustrating a procedure of a matching processing according to the first embodiment;

FIG. 5A is a diagram illustrating a flow of converting a two-dimensional image and depth information input to a first input unit 201 into a feature amount;

FIG. 5B is a diagram illustrating a flow of converting a two-dimensional image and depth information input to the first input unit 201 into a feature amount;

FIG. 6 is a flowchart illustrating a procedure of a training processing according to the first embodiment;

FIG. 7 is a schematic diagram illustrating an operation of the training processing according to the first embodiment;

FIG. 8 is a flowchart illustrating a procedure of a training processing according to a second embodiment;

FIG. 9 is a block diagram illustrating an example of a functional configuration according to a third embodiment;

FIG. 10 is a flowchart illustrating a procedure of a matching processing according to the third embodiment; and

FIGS. 11A to 11B are flowcharts illustrating a procedure of the training processing according to the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

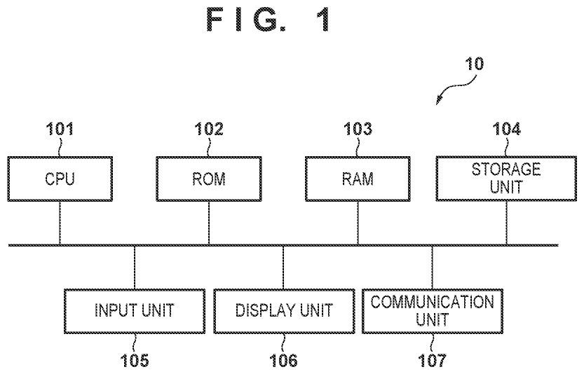

FIG. 1 is a diagram illustrating an example of a hardware configuration of an image processing apparatus. An image processing apparatus 10 includes a CPU 101, a ROM 102, a RAM 103, a storage unit 104, an input unit 105, a display unit 106, and a communication unit 107. Although the present embodiment describes face authentication, the image processing apparatus 10 can perform authentication of any object without being limited to face authentication.

The CPU 101 performs overall control the image processing apparatus 10 by executing the programs stored in the ROM 102.

The ROM 102 is a nonvolatile memory, and stores various data and programs.

The RAM 103 temporarily stores various data from each of the components of the image processing apparatus 10. In addition, the RAM 103 deploys a program to make the program executable by the CPU 101.

The storage unit 104 stores parameters for performing feature amount conversion. The storage unit 104 includes, for example, a Hard Disk Driven (HDD), a flash memory, and various types of optical media or the like.

The input unit 105, which is an apparatus configured to accept input from a user, includes a keyboard, a touch panel, and a dial, for example. The input unit 105 is used in setting for reconstructing information such as texture, shape, temperature, and motion of the face of a person.

The display unit 106, which is an apparatus configured to display the reconstructing result of the face information of the person, includes a liquid crystal display (LCD) and an organic EL display, for example.

The communication unit 107 allows the image processing apparatus 10 to communicate with an image capturing apparatus (not illustrated), an external apparatus (not illustrated), or the like.

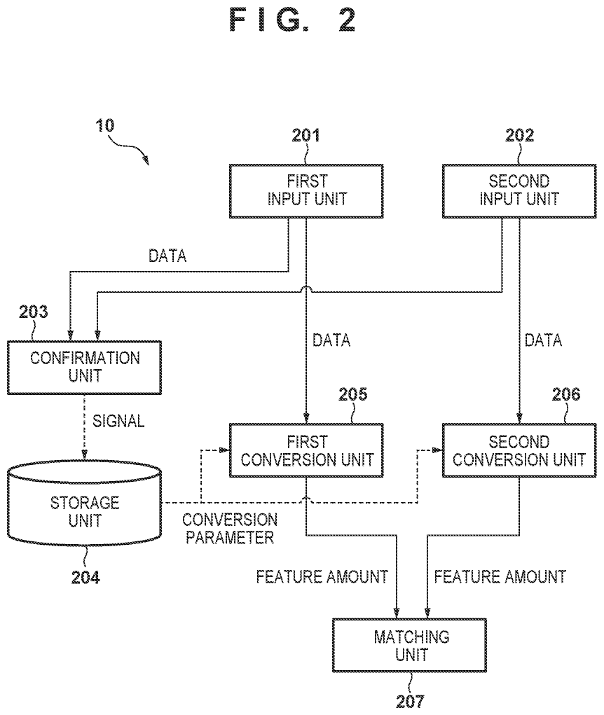

FIG. 2 is a block diagram illustrating an example of a functional configuration according to the first embodiment.

The image processing apparatus 10 includes a first input unit 201, a second input unit 202, a confirmation unit 203, a storage unit 204, a first conversion unit 205, a second conversion unit 206, and a matching unit 207.

The first input unit 201 accepts a first data set.

The second input unit 202 accepts a second data set.

The confirmation unit 203 confirms the modal type of the first data set and the modal type of the second data set.

The storage unit 204 stores parameters for performing feature amount conversion.

The first conversion unit 205 converts the first data set into feature amount using the conversion parameters read from the storage unit 204 based on the result of confirmation by the confirmation unit 203.

The second conversion unit 206 converts the second data set into a feature amount using conversion parameters read from the storage unit 204 based on the result of confirmation by the confirmation unit 203.

The matching unit 207 performs face authentication by comparing the feature amount extracted from the first data set with the feature amount extracted from the second data set.

### <Input Data Matching Processing Phase>

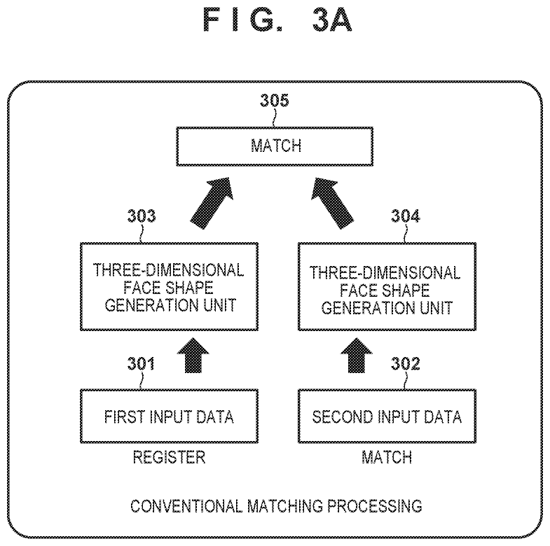

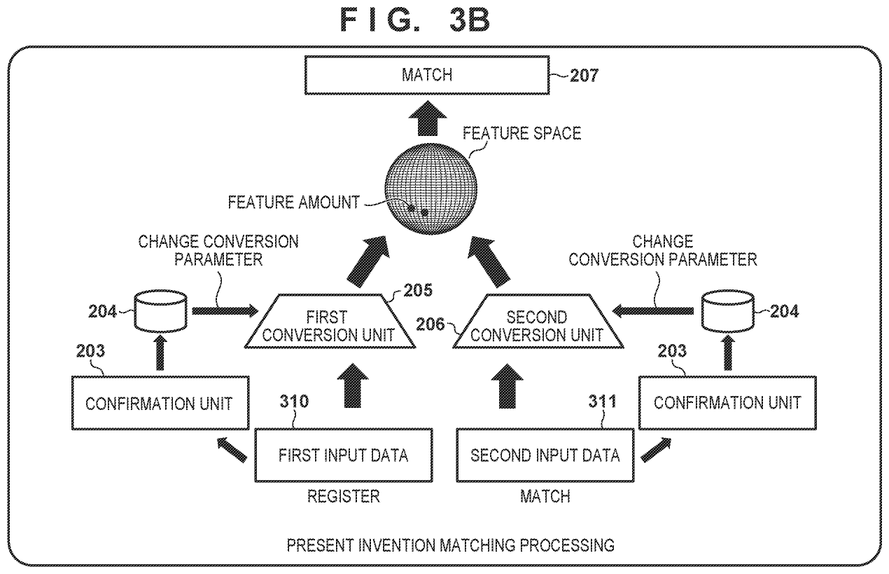

FIGS. 3A to 3B are schematic diagrams illustrating a comparison between a conventional matching processing and the matching processing according to the first embodiment.

FIG. 3A is a diagram illustrating a conventional matching processing. In FIG. 3A, a three-dimensional face shape generation unit 303 generates a three-dimensional face shape data from a first input data 301 including a face to be registered. A three-dimensional face shape generation unit 304 generates three-dimensional face shape data from second input data 302 including a face for matching. When the first input data 301 is a two-dimensional face image in this matching processing, the depth information of the face shape required for generating the three-dimensional face shape data is insufficient, and thus accuracy of the three-dimensional face shape data is low. In addition, converting two-dimensional image into three-dimensional face shape data reduces the resolution of the three-dimensional face shape data, whereby detailed features of the face to be registered are lost. When, on the other hand, the second input data 302 is a 2.5-dimensional face image, the three-dimensional face shape data generated from the 2.5-dimensional face image has a high accuracy. Therefore, the face authentication accuracy decreases when performing matching 305 (face authentication) three-dimensional face shape data generated by the three-dimensional face shape generation unit 303 and three-dimensional face shape data generated by the three-dimensional face shape generation unit 304. In the present specification, “matching” and “face authentication” are used as terms having a same meaning.

FIG. 3B is a diagram illustrating a matching processing of the present invention. In FIG. 3B, the confirmation unit 203 confirms the modal type of first input data 310. The first conversion unit 205 converts the first input data 310 into a feature amount using a conversion parameter read from the storage unit 204 based on the result of confirmation by the confirmation unit 203. The confirmation unit 203 confirms the modal type of second input data 311. The second conversion unit 206 converts the second input data 311 into a feature amount using a conversion parameter read from the storage unit 204 based on the result of confirmation by the confirmation unit 203.

Here, the conversion parameter is a result of training of the neural network with the feature of the input data in accordance with the modal type of the input data. Therefore, the image processing apparatus 10 can perform highly accurate face authentication even when images of different modal types are input. In addition, the image processing apparatus 10 can extract a feature of face from face data of various modal types. The feature of face includes, for example, a feature of texture extracted from the RGB image, a feature of shape such as unevenness of the face, and a feature of temperature distribution.

In the present invention, the neural network is trained to enhance the similarity between face images including an identical face. Therefore, the matching unit 207 can calculate the similarity between the face images based on the inner product and the angle between the feature amounts extracted from each of the face images. Therefore, the present invention does not require any special processing other than a calculation processing of the similarity between face images. As such, the matching unit 207 can perform face authentication using a single type of similarity without depending on the modal type of the face image. This advantage is one of the characteristics of the present invention.

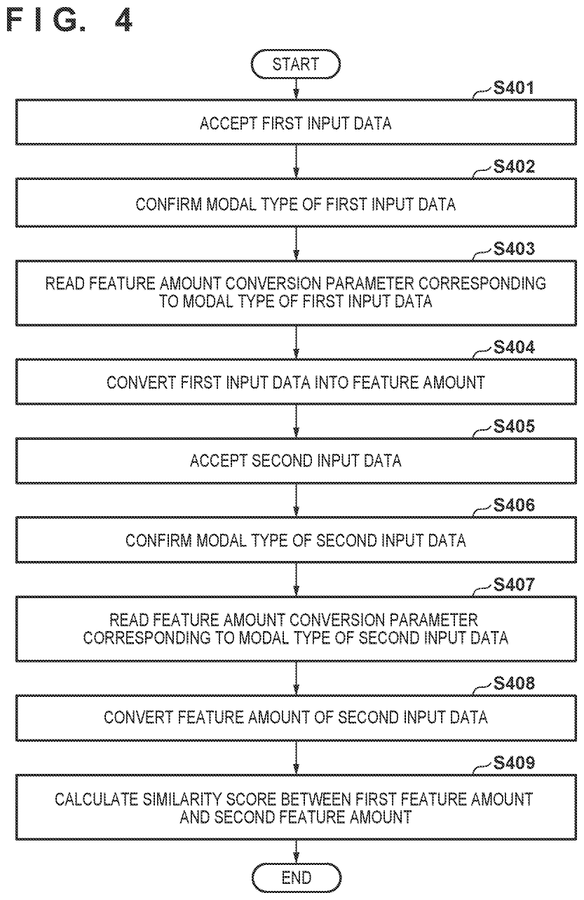

FIG. 4 is a flowchart illustrating a procedure of a matching processing according to the first embodiment.

The image processing apparatus 10, in a case where two face images are input, determines whether or not a face captured in one of the face images is identical to a face captured in the other face image, based on comparison between the feature amount extracted from one of the face images and the feature amount extracted from the other face image. Here, each of the two face images may be any of a two-dimensional RGB image, a normal vector having three-dimensional face shape information, a curvature, a stereo image, and a depth image. For example, the face data for matching may be a combination of a two-dimensional image and a depth image or may be a combination of the aforementioned plurality of images.

At S401, the first input unit 201 accepts first input data.

At S402, the confirmation unit 203 confirms the modal type of the first input data.

At S403, the first conversion unit 205 reads, from the storage unit 204, conversion parameters for performing conversion into a feature amount corresponding to the modal type of the first input data confirmed at S402, and sets the read conversion parameters in a DNN described below.

At S404, the first conversion unit 205 converts the first input data into a feature amount. Here, the first conversion unit 205 includes, for example, a convolutional neural network described in “Deng, et. Al., ArcFace: Additive Angular Margin Loss for Deep Face Recognition. In CVPR, 2019” (hereinafter referred to as a non-patent document 1), and a Deep Neural Network (DNN, in the following) referred to as a Transformer network described in “Florian Schroff, Dmitry Kalenichenko, and James Philbin. Facenet: A unified embedding for face recognition and clustering. In CVPR, 2015” (hereinafter referred as a non-patent document 2). Note that, the conversion parameters include parameters such as number of layers of neurons, number of neurons, connection weight, or the like.

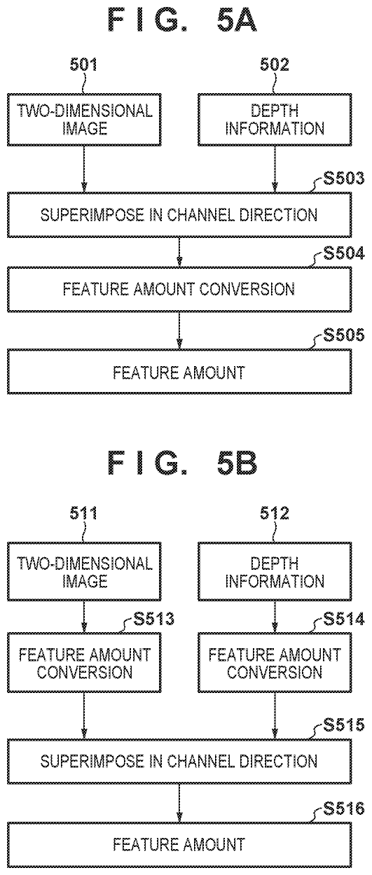

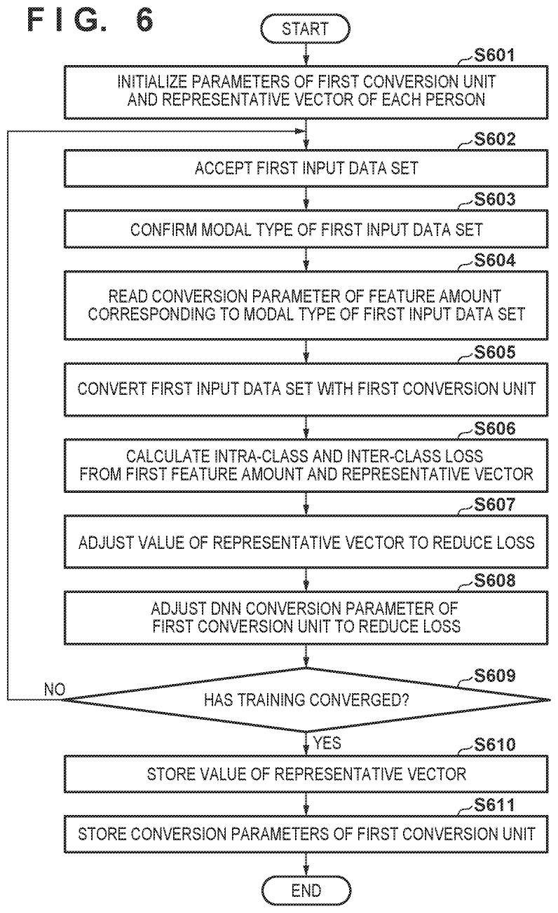

Here, FIGS. 5A to 5B illustrate a procedure of feature amount conversion according to the first embodiment.

FIG. 5A is a diagram illustrating a flow of converting a two-dimensional image and depth information input to the first input unit 201 into a feature amount. The first conversion unit 205 acquires the feature amount 505 (S505) by superimposing the two-dimensional image 501 and the depth information 502 in the channel direction (S503 to S504).

FIG. 5B is a diagram illustrating a flow of converting a two-dimensional image and depth information input to the first input unit 201 into a feature amount. The first conversion unit 205 converts a two-dimensional image 511 into a feature amount using a conversion parameter (S513), and converts depth information 512 into a feature amount using a different conversion parameter from the conversion parameter described above (S514). The first conversion unit 205 then superimposes the feature amounts converted at S513 and S514 in the channel direction (S515) to acquire a feature amount at S516.

Here, a DNN that converts a two-dimensional image into a feature amount and a DNN that converts depth information into a feature amount may share a layer of a previous stage of the DNN each other, and may also partially share only a layer of the subsequent stage in accordance with the state of the face of the person. As has been described above, there are a plurality of methods as a method for converting input data into a feature amount, and the methods illustrated in FIGS. 5A to 5B are exemplary methods for converting input data into a feature amount. Here, since the second conversion unit 206 can convert the second input data into a feature amount using a method similar to that of the first conversion unit 205, detailed description thereof will be omitted.

Since the image processing apparatus 10 performs, in S405 to S408, processing on the second input data same as that of S401 to S404, description thereof will be omitted. Noted that, the second input unit 202 performs the processing of S405, and the second conversion unit 206 performs the processing of S406 to S408.

And thus, the first input data and the second input data are respectively converted into feature amounts. The feature amount of the first input data is denoted by f₁, and the feature amount of the second input data is denoted by f₂. The feature amounts f₁ and f₂ are one-dimensional vectors. The feature amounts f₁ and f₂ are subjected to the processing in the fully-connected layer of the DNN to be converted into a one-dimensional vector. In addition, the conversion parameters of the DNN of the first conversion unit 205 and the conversion parameters of the DNN of the second conversion unit 206 may not be identical. However, the number of output channels of neurons in the final layer of the DNN are identical for the first conversion unit 205 and the second conversion unit 206. And thus, f₁ and f₂ are of a same dimension.

At S409, the matching unit 207 calculates a similarity score between the feature amount f₁ and the feature amount f₂ using the following Formula 1. Here, an index indicating the similarity (i.e., similarity score) between feature amounts is represented by an angle between feature amount vectors (see non-patent document 1).

$$Similarity score ( {f}_{1} , {f}_{2} ) := cos ( {θ}_{12} ) = < {f}_{1} , {f}_{2} > / ( \vert {f}_{1} \vert \cdot \vert {f}_{2} \vert ) \qquad ( Formula 1 )$$

Here, θ₁₂ is an angle formed by the feature amount vectors f₁ and f_{2.} <f₁, f₂>is the inner product of f₁ and f_{2.} |f₁| is the length of f₁. |f₂| is the length of f₂.

Subsequently, the matching unit 207 determines that the face included in the first input data and the face included in the second input data are identical, when the calculated similarity score is equal to or less than a threshold value, and terminates the matching processing. On the other hand, the matching unit 207 determines that the face included in the first input data and the face included in the second input data are not identical, when the calculated similarity score is not equal to or less than the threshold value, and terminates the matching processing.

### <Training Processing Phase>

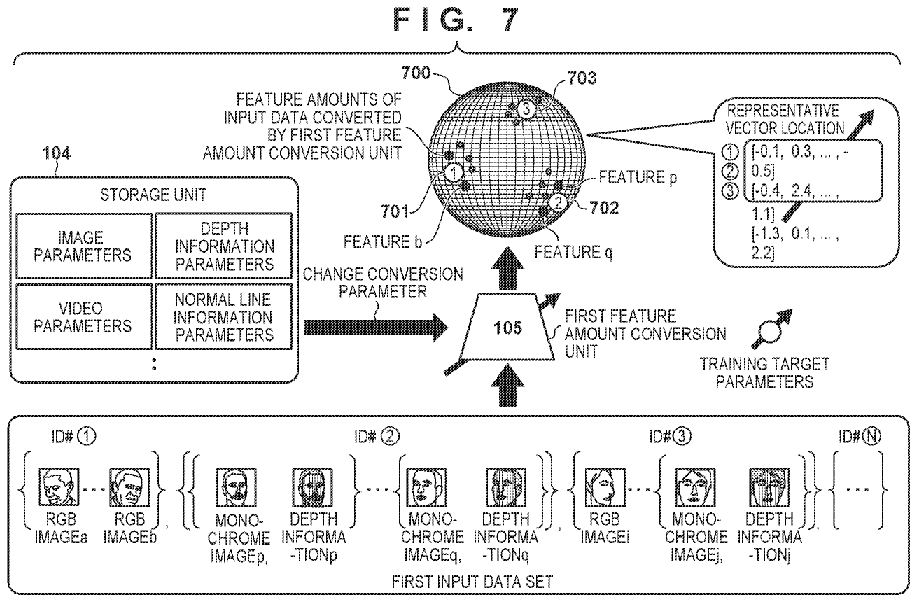

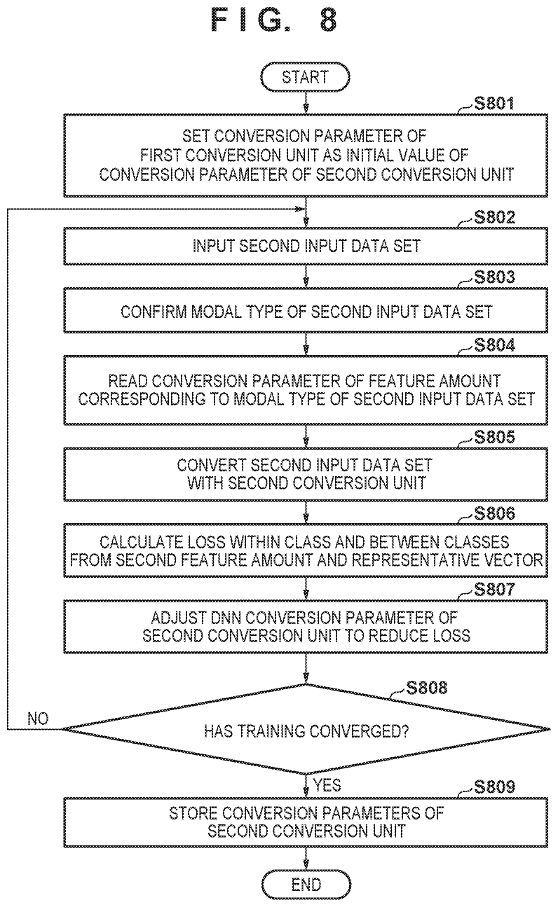

FIG. 6 is a flowchart illustrating a procedure of training processing according to the first embodiment. FIG. 7 is a schematic diagram illustrating an operation of the training processing according to the first embodiment.

Here, training of the DNN using the representative vector method will be described. The representative vector method is a training method of face authentication that improves training efficiency of the DNN by setting feature amount vectors representing respective persons (see non-patent document 1).

At S601 of FIG. 6, the first conversion unit 205 initializes parameters and representative vectors v₁ to vₙ of the DNN with random numbers. Here, 1 to n are IDs of all the persons included in a training image. Each representative vectors v is a d-dimensional vector. Here, d is a predetermined value.

At S602, the first input unit 201 accepts images I₁ to Iₘ randomly selected from the first input data set. The first input data set includes a plurality of image data groups. The image data group includes one or more image data capturing only one person. Each image data group has ID information of a person. Here, image data refers to image data having various modal types. Image data in the present embodiment includes, for example, an RGB image acquired by a digital camera, a monochrome image captured by an infrared camera at night, and depth information acquired by a TOF sensor simultaneously with the monochrome image.

For example, ID #1 in FIG. 7 indicates an image data group including only a plurality of RGB images (e.g., RGB images a and RGB images b). ID #2 indicates an image data group including only a pair of a monochrome image and depth information (e.g., a monochrome image p and depth information p, and a monochrome image q and depth information q). ID #3 indicates an image data group including an RGB image, and a pair of a monochrome image and depth information (e.g., an RGB image i, a monochrome image j, and depth information j). As has been described above, the image data group of each ID may include only image of a single modal type, or may include images of a plurality of modal types.

At S603, the confirmation unit 203 confirms the modal type of the first input data set.

At S604, the first conversion unit 205 reads, from the storage unit 204, a conversion parameter corresponding to the modal type of the first input data confirmed by the confirmation unit 203. And thus, the conversion parameter of the DNN of the first conversion unit 205 is changed.

At S605, the first conversion unit 205 converts each data Iᵢ of the first input data set (i.e., face image data) into a feature amount fᵢ, using a DNN to which a conversion parameter corresponding to the modal type of the first input data set is applied. Here, the feature vector fᵢ is a d-dimensional vector.

At S606, the first conversion unit 205 calculates a similarity of feature amounts between the face image of each person and the representative vector (intra-class similarity), and a similarity of feature amounts between the face image of each person and a representative vector of another person (inter-class similarity) with Formula 2 and Formula 3 below.

Intra-class similarity score (fᵢ)=similarity score (fᵢ,V_{y(i)}) (Formula 2)

Inter-class similarity score (fᵢ)=Σ_{j≠y(i)}similarity score(fᵢ,Vⱼ) (Formula 3)

Here, y(i) is the ID number of the person in each input data Iᵢ.

The first conversion unit 205 calculates a loss value to be used for training of the DNN, using the intra-class similarity score, the inter-class similarity score, and Formula 4.

Loss value=Σᵢinter-class similarity score(fᵢ)−λ×intra-class similarity score(fᵢ) (Formula 4)

Here, λ is a weight parameter for balancing the training. The aforementioned loss value is an example, and may be calculated by various known methods such as a similarity score with margin, cross entropy, or the like.

From S607 to S608, the first conversion unit 205 updates the conversion parameter to reduce the calculated loss value.

At S607, the first conversion unit 205 updates the value of the representative vector. At S608, the first conversion unit 205 updates the parameters of the DNN. Here, update target of the conversion parameter of the DNN is only the conversion parameter corresponding to the modal type of the first input data set read at S604. In addition, the first conversion unit 205 updates the conversion parameters of the DNN using a general backpropagation method. And thus, the representative vector functions more effectively as a value representing the feature of each face of the person. The DNN of the first conversion unit is trained such that feature amounts of the face of a same person become closer to each other.

At S609, the first conversion unit 205 determines whether or not training of the DNN has converged, based on, for example, whether or not the loss value is equal to or less than a predetermined value. When the loss value is equal to or less than a predetermined value (Yes at S609), the first conversion unit 205 advances the processing to S610. When the loss value is not equal to or less than the predetermined value (No at S609), the first conversion unit 205 returns the processing to S602.

At S610, the storage unit 204 stores values of the representative vectors V₁ to Vₙ.

At S611, the storage unit 204 stores the parameters of the DNN of the first conversion unit 205.

A feature space 700 in FIG. 7 schematically illustrates a result at the completion of the training processing of the DNN. A representative vector 701, a representative vector 702 and a representative vector 703 in the feature space 700 are feature vectors respectively representing the persons indicated by ID #1 to ID #3. The DNN of the first conversion unit 205 is trained such that the representative vector 701 of the person of ID #1 is located in the vicinity of a feature a and a feature b, and the representative vector 702 of the person of ID #2 is located in the vicinity of a feature p and a feature q. The feature a and the feature b are features of the person of ID #1, and each of them is illustrated by a black circle in FIG. 7. The feature p and the feature q are features of the person of ID #2, and each of them is illustrated by a black circle in FIG. 7. Although the features of the person of ID #3 are not illustrated in FIG. 7, the DNN of first conversion unit 205 is trained such that the representative vector 703 of the person of ID #3 is located in the vicinity of the features of the person of ID #3.

The first conversion unit 205 mainly extracts, from the RGB image, features of positions and contours of organ points (e.g., eyes, nose and mouth) of the face of a person. In addition, the first conversion unit 205 also extracts features related to unevenness of the face such as hollow of the eyes and height of the nose, based on the information such as color change and shading in the image.

The first conversion unit 205 extracts features of positions and contours of organ points of the face of a person from a monochrome image, similarly to an RGB image. Since it is difficult to extract features of the face color from a monochrome image, the first conversion unit 205 uses features of detailed unevenness from depth information in order to complement the features extracted from the monochrome image. And thus, the first conversion unit 205 can extract detailed shape information for identifying the face of a person.

As such, training of the DNN is performed by arranging various features of the face of a person extracted from the input data in a same feature space 600, while the conversion parameter of the first conversion unit 205 is changed in accordance with the modal type of the input data. And thus, the image processing apparatus 10 can perform highly accurate face authentication even when input data of various modal types are accepted.

### <Derivatives of Modal Type of Input Data>

Modal types of the input data accepted by the first input unit 201 and the second input unit 202 include, without being limited thereto, a two-dimensional RGB image and three-dimensional shape information. Here, a specific example of input data (image data) having a modal type other than a two-dimensional RGB image and three-dimensional shape information will be described.

The input data includes a plurality of images captured by switching image capturing settings of the digital camera into various settings. The plurality of images are input to the first input unit 201 or the second input unit 202. The image capture settings include, for example, shutter speed, exposure, aperture, white balance, and ISO sensitivity. The input data may be, for example, a pair of a noisy image captured by capturing settings of a high shutter speed and an underexposure, and a blurred image captured with capturing settings of a sufficient exposure. Alternatively, the input data may be a pair of an image captured using auxiliary illumination such as a strobe and an image captured without any auxiliary illumination.

Furthermore, the input data may be an infrared light image captured by an infrared camera, an image captured using infrared pattern projection light, a spectroscopic image acquired using a spectroscope, or a polarized image captured by a polarization camera. The input data may be a combination of an RGB image and any of the aforementioned images. The images described above may have different resolutions from each other or may be scaled to have a same resolution.

The input data may be a plurality of images separately focused for each incident angle of a light flux with a microlens array or the like, or a plurality of images captured by a camera including a fly-eye lens or a group of cameras each having a different optical axis. Such parallax images includes distance information, and therefore has more features of an uneven shape of a face than an image without parallax. And thus, the first conversion unit 205 and the second conversion unit 206 can extract the feature of the uneven shape of the face from the parallax images with a high accuracy.

### <Effect of First Embodiment>

Even when the modal type of the face data for registration and the modal type of the face data for matching are different from each other, the first conversion unit 205 can be trained in a same feature space with the feature extracted from the face data for registration and the feature extracted from the face data for matching. According to the present embodiment, therefore, it is possible to perform face authentication with a high accuracy without generating an intermediate three-dimensional face shape or the like.

In addition, there may be a case where face authentication becomes easier by combining the feature extracted from a two-dimensional face image with the feature of depth. For example, an operation of a case will be described in which input data including a set of a two-dimensional face image with the face oriented forward and depth information as face data for registration, and a two-dimensional face image with the face oriented sideways as face data for matching are input to the image processing apparatus 10. At this time, it is difficult for the first conversion unit 205 to extract so-called chiseled feature of a face such as the height of the nose from a two-dimensional face image (face image with the face oriented forward). On the other hand, the second conversion unit 206 can extract the chiseled feature of the face of a person from a two-dimensional face image (i.e., a face image in which the face is oriented sideways).

However, in a case where a set of a two-dimensional face image and depth information exists as face data for registration, the first conversion unit 205 can extract the chiseled feature of the face of the person from the depth information. The first conversion unit 205 therefore has both the feature extracted from the two-dimensional face image and the feature extracted from the depth information. And thus, the matching unit 207 can perform matching, by taking into account the feature including the chiseled characteristics of the face, the feature, which is extracted from the set of the two-dimensional face image and the depth information by the first conversion unit 205, with the feature, which is extracted from the two-dimensional face image by the second conversion unit 206. And thus, the accuracy of face authentication is further improved.

### Second Embodiment

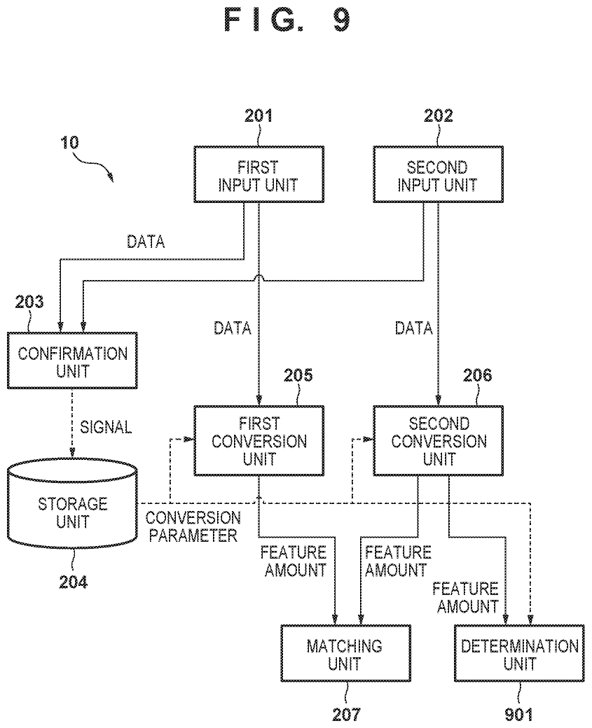

Generally, most of the data used for face authentication are images due to the ease of data acquisition, and there are less pieces of data other than images. The face authentication accuracy of performing face authentication using pieces of data other than images may be low, due to imbalance between the number of images and the number of pieces of data other than images. In order to prevent the foregoing, the training of the DNN is performed twice. In the first training, the DNN is trained to learn representative vectors using only images. In the second training, the DNN is trained to learn pieces of data other than the image with the representative vector fixed. Here, the first training of the DNN is performed by the training processing illustrated in FIG. 6. The second training of the DNN is performed by training processing illustrated in FIG. 8 described below.

FIG. 8 is a flowchart illustrating a procedure of training processing according to the second embodiment.

In the first training of the DNN, the DNN is trained with feature conversion specialized for only single images using a set of only single images (first input data set). Here, a single image refers to an RGB image representing the texture of a face to be input to the DNN, and not a plurality of images representing a set of an image and depth information. In the second training of the DNN, the DNN of the second conversion unit 206 is trained with feature conversion specialized for pieces of data other than images by using a set of pieces of data other than images (second input data set).

Details of the first DNN training have been described in the first embodiment. However, the first input data set includes only single image, and the conversion parameters of the first conversion unit 205 are for only single image. In the following, the second training of the DNN will be described, referring to FIG. 8.

At S801, a conversion parameter, which is a duplication of the conversion parameter of the DNN of the first conversion unit 205, is set as an initial value of the conversion parameter of the DNN of the second conversion unit 206.

The processing S801 to S804 are similar to the processing S602 to S609 of FIG. 6. However, the updating processing of the representative vectors V₁ to Vₙ as that at S607 of FIG. 6 is not performed in FIG. 8. In other words, the value of the representative vector stored at S610 of FIG. 6 is used in FIG. 8. And thus, the DNN is trained such that the feature amount extracted from the pieces of data other than the image comes close to the representative vector subjected to training using the single images.

At S808, the second conversion unit 206 determines whether or not the training has converged, based on, for example, whether or not the loss value is equal to or less than a predetermined value. When the loss value is equal to or less than a threshold value (Yes at S808), the second conversion unit 206 advances the processing to S809. When, on the other hand, the loss value is not equal to or less than the predetermined value (No at S808), the second conversion unit 206 returns the processing to S802.

At S809, the second conversion unit 206 stores the parameters of the DNN and terminates the processing. Here, the value of the representative vector is used only in training the DNN, and the value of the representative vector is not used in face matching.

Although the training method of the DNN using the representative vector has been described above, the training of the DNN may be performed by a method that does not use the representative vector. For example, in the first training processing, the second conversion unit 206 calculates only intra-class and inter-class loss values at S606, and generates the feature space without performing the processing of S607. Subsequently, in the second training processing, the second input unit 202 accepts the first data set to be paired with the second data set at S602. The second conversion unit 206 then performs feature amount conversion also on the first data set similarly to the second data set, calculates a loss based on the first feature amount and the second feature amount, and performs parameter adjustment by a backpropagation method.

### <Effect of Second Embodiment>

In the first training of the DNN, the first conversion unit 205 can generate a sufficiently trained feature space and representative vector of a face by training the DNN using a large number of single images. And thus, in the second training of the DNN, the second conversion unit 206 can be trained with the DNN by using a small number of pieces of data other than single images.

### Third Embodiment

When the imbalance between the number of images and the number of pieces of data other than images occurs, face authentication accuracy is significantly reduced in a case of performing face authentication using a small number of images or pieces of data other than images. In order to prevent decrease of face authentication accuracy, each of the face data for registration and the face data for matching may be either a sufficient number of images or pieces of data other than images.

For example, the first input unit 201 accepts a two-dimensional RGB image only, and the second input unit 202 accepts a set of a monochrome image and depth information only. In this case, the first conversion unit 205 trains the DNN using only RGB images including the faces oriented forward. On the other hand, the second conversion unit 206 trains the DNN using monochrome images including the faces oriented in various directions and depth information. The first conversion unit 205 then calculates the loss between the RGB image and the set of the monochrome image and the depth information having a same ID. Here, it is assumed that the first conversion unit 205 does not calculate loss values between RGB images each other, and between sets of monochrome images and depth information each other.

### <Effect of Third Embodiment>

When there are sufficient training data for each of the RGB images to be accepted by the first input unit 201 and sets of monochrome images and depth information to be accepted by the second input unit 202, the first conversion unit 205 and the second conversion unit 206 can train the DNN by limiting to the aforementioned combination of training data. At this time, the RGB image parameters of the DNN of the first input unit 201 are adjusted such that feature amounts of RGB images can be easily matched with feature amounts of sets of monochrome images and depth information. In addition, the parameters for the sets of monochrome images and depth information of the DNN of the second input unit 202 are adjusted such that feature amounts of sets of the monochrome images and depth information can be easily matched with feature amounts of the RGB images. And thus, the image processing apparatus 10 can perform highly accurate face authentication, based on a limited combination of images and pieces of data other than images.

### Fourth Embodiment

Another person who is not the person registered in the face authentication system may pass the face authentication by using a non-living body material such as a photograph in which the registered person is captured. This kind of operation, so-called “spoofing”, is likely to occur in a face authentication system that uses a two-dimensional image for face authentication. In order to prevent spoofing, a determination apparatus configured to perform spoofing determination is provided separately from an image processing apparatus that only performs face authentication. Specifically, the determination apparatus acquires a near-infrared image separately from a visible light image, extracts depth information from the near-infrared image, and determines whether or not the person captured in the image is a living body.

When the determination apparatus has determined that the person captured in the image is a living body, the image processing apparatus performs face authentication of the person. As has been described above, spoofing determination and face authentication are processed in series, which takes a longer time to complete all the processing. In addition, the determination apparatus determines spoofing using only depth information acquired from a near-infrared image, it cannot cope with spoofing in a case where another person is disguising as the registered person.

The image processing apparatus 10 of the present invention therefore performs spoofing determination and face authentication simultaneously in a case where the data for matching holds any one of three-dimensional information, temperature information, and motion information. Here, three-dimensional information is, for example, information including a pair of stereo images, depth information, normal vector, point cloud coordinates, and face shape such as curvature. Temperature information is, for example, temperature of the face measured when a thermal camera or the like captures the face. Motion information is, for example, a video and optical flow including information of motion of an object. And thus, spoofing determination and face authentication can be performed simultaneously, thereby the time required for performing all the processing can be reduced. In addition, the image processing apparatus 10 can further improve the determination accuracy of spoofing by using information other than depth information. The image processing apparatus 10 can also use, as features of the two-dimensional image, features of texture such as visual perception and color of skin for spoofing determination. Therefore, the image processing apparatus 10 can determine spoofing by another person with a high accuracy even when the other person has disguised as the registered person.

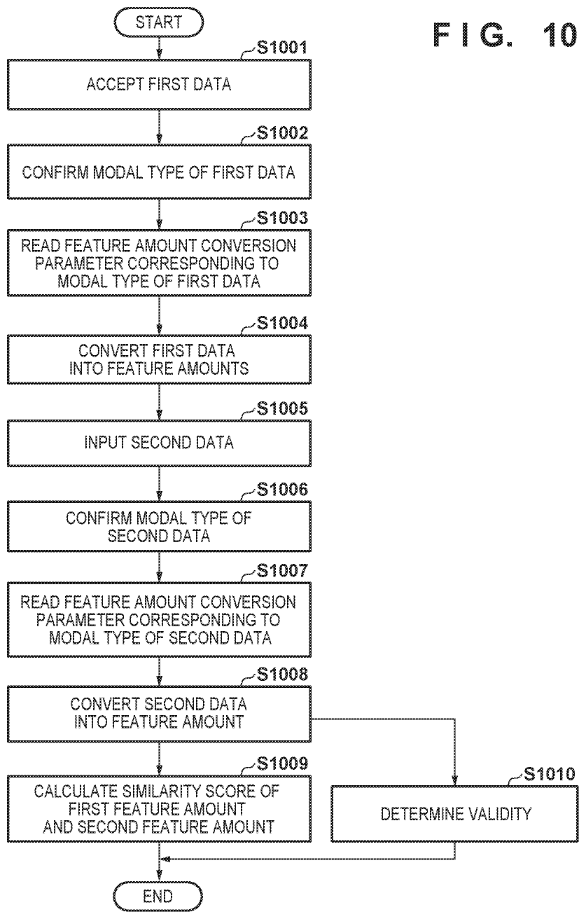

FIG. 9 is a block diagram illustrating an example of a functional configuration of the third embodiment.

The image processing apparatus 10 includes the first input unit 201, the second input unit 202, the confirmation unit 203, the storage unit 204, the first conversion unit 205, the second conversion unit 206, the matching unit 207, and a determination unit 901.

### <Input Data Validity Determination Phase>

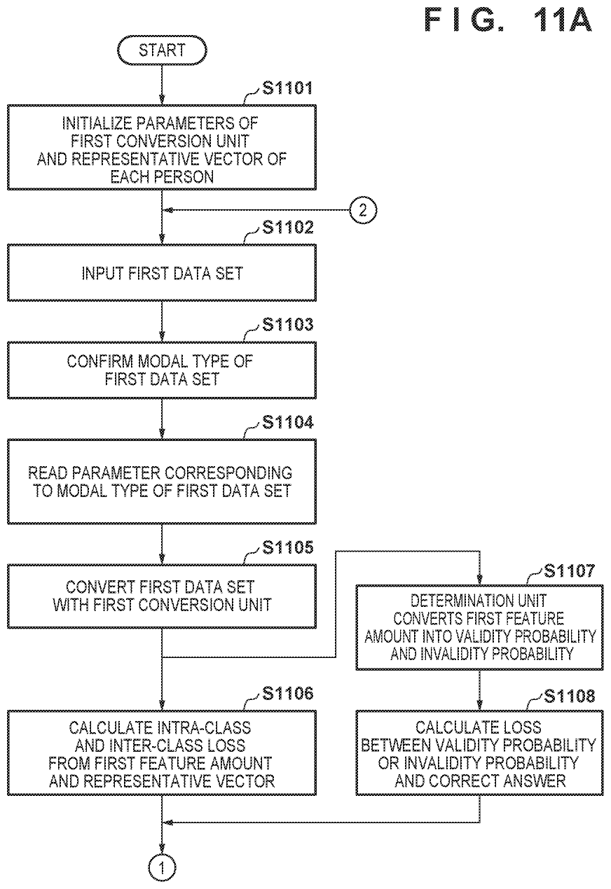

FIG. 10 is a flowchart illustrating a procedure of a matching processing of the third embodiment.

The processing S1001 to S1009 are identical to the processing S101 to S109 illustrated in FIG. 4 of the first embodiment. The type of the first data to be accepted by the first input unit 201 at S1001 is not particularly limited. The second data to be accepted by the second input unit 202 at S1005 includes at least one of three-dimensional shape information, temperature information, and motion information of the face.

At S1110, the determination unit 901 determines the validity of the second data, based on whether or not the likelihood based on the feature amounts of the second data and the correct answer data exceeds a threshold value. Here, validity is an index indicating whether or not the second data is valid data when the matching unit 207 performs matching between the feature amount of the first data and the feature amount of the second data. In other words, the determination unit 901 determines that the validity of the second data is “invalid” when the likelihood is less than a threshold value. When, on the other hand, the likelihood exceeds the threshold value, the determination unit 901 determines that the validity of the second data is “valid”.

The determination unit 901 includes a DNN, for example. The DNN, including a fully connected layer and a sigmoid function, outputs a probability (i.e., likelihood) indicating that the second data is valid and a probability indicating that the second data is invalid. Here, the determination unit 901 determines that the second data is valid when the probability indicating that the second data is valid is larger than the probability indicating that the second data is invalid. When, on the other hand, the probability indicating that the second data is invalid is larger than the probability indicating that the second data is valid, the determination unit 901 determines that the second data is invalid. Note that the configuration of the DNN is not limited to the foregoing, and the DNN may include a convolutional layer, an activation function other than those described above, and a softmax function. The number of layers included in the DNN may be three or more.

### <Training Processing Phase>

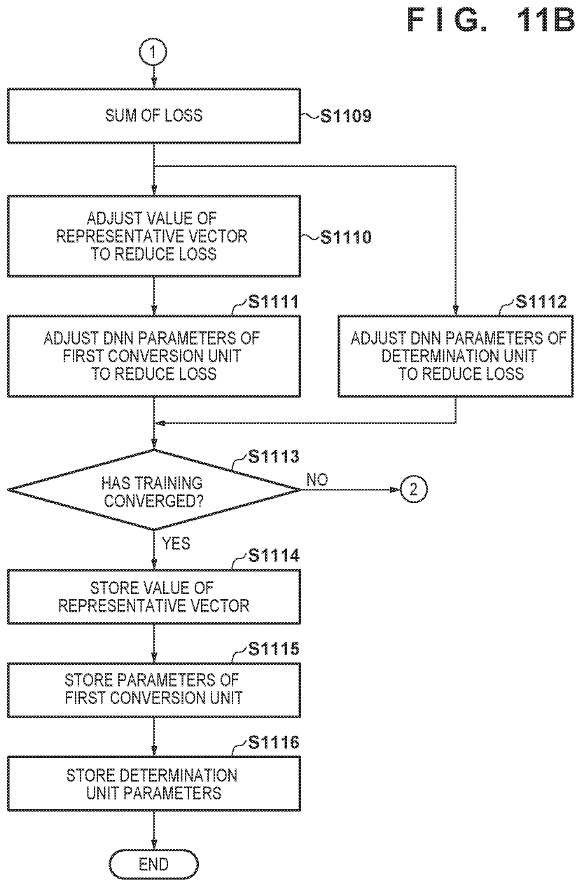

FIGS. 11A to 11B are flowcharts illustrating a procedure of a training processing according to the third embodiment.

The processing S1101 to S1106 are similar to the processing S601 to S606 in FIG. 6 of the first embodiment. The first input data set to be input at S1102 includes at least one of three-dimensional shape information, temperature information, and motion information of the face.

At S1107, the determination unit 901, by using the DNN, respectively converts the first feature into a probability (validity probability) indicating that the first input data set is valid and a probability (invalidity probability) indicating that the first input data set is invalid. Here, the determination unit 901 includes, for example, a fully connected layer and a sigmoid function. Each of the validity probability and the invalidity probability is represented by a real number from 0 to 1, making the sum of the validity probability and the invalidity probability to be 1.

At S1108, the determination unit 901 calculates the loss value based on the validity probability or the invalidity probability and the correct answer data. Here, the correct answer data is data represented by either 0 or 1, and the loss value is calculated using the binary cross-entropy loss. Here, the loss value is not limited thereto, and may be the ordinary cross-entropy loss.

At S1109, the determination unit 901 calculates the sum of the loss value calculated at S1106 and the loss value calculated at S1108. Here, the sum may be the total sum of each of the loss values, or the total sum calculated by weighting each of the loss values.

The processing S1110 and S1111 are similar to processing S207 and S208 illustrated in FIG. 6 of the first embodiment.

At S1112, the image processing apparatus 10 updates the parameters of the DNN of the first conversion unit 205 and the determination unit 901 to reduce the calculated loss value. The updating method is a backpropagation method commonly used in a DNN. And thus, the DNN of the determination unit 901 is improved such that it can determine spoofing.

At S1113, the image processing apparatus 10 determines whether or not training of the DNN has converged, based on, for example, whether or not the loss value is equal to or less than a predetermined value. When the loss value is equal to or less than the predetermined value (Yes at S1113), the image processing apparatus 10 determines that training of the DNN has converged, and the processing proceeds to S1114. When, on the other hand, the loss value is not equal to or less than the predetermined value (No at S1113), the image processing apparatus 10 determines that training of the DNN has not converged, and the processing returns to S1102.

At S1114, the storage unit 204 stores values of the representative vectors V₁ to Vₙ.

At S1115, the storage unit 204 stores conversion parameters of the DNN of the first conversion unit 205.

At S1116, the storage unit 204 stores the conversion parameters of the DNN of the determination unit 901.

### <Effect of Fourth Embodiment>

In a case where the face data for matching includes at least one of three-dimensional shape information, temperature information, and motion information of the face, the image processing apparatus is allowed to perform face authentication and spoofing determination in parallel, thereby the accuracy of face authentication is further improved.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application 2022-152804, filed Sep. 26, 2022 which is hereby incorporated by reference herein in its entirety.

What is claimed is:

1. An image processing apparatus comprising:
at least one processor; and
at least one memory coupled to the at least one processor, the memory storing instructions that, when executed by the processor, cause the processor to act as:
an extraction unit configured to extract a first feature from first data of a first modal type, the first data including information of a first object that is registered, and extract a second feature from second data of a second modal type that is different from the first modal type, the second data including information of a second object for matching, and
a determination unit configured to determine whether or not the first object and the second object are identical, based on the first feature and the second feature, wherein,
the extraction unit is trained to extract the first feature and the second feature to be similar when the first object and the second object are identical.

2. The image processing apparatus according to claim 1, further comprising a selection unit configured to select parameters of the extraction unit respectively corresponding to the first modal type and the second modal type, wherein
the extraction unit extracts the first feature from the first data, based on the parameter corresponding to the first modal type, and extracts the second feature from the second data, based on the parameter corresponding to the second modal, and
the determination unit determines that the first object and the second object are identical when a similarity between the first feature and the second feature is equal to or less than a threshold value.

3. The image processing apparatus according to claim 2, wherein the determination unit determines that the first object and the second object are not identical when the similarity is not equal to or less than the threshold value.

4. The image processing apparatus according to claim 1, further comprising a validity determination unit configured to determine whether or not the second data is valid when the second data includes predetermined information, wherein
the validity determination unit determines that the second data is valid when a likelihood of the second object based on the second feature and correct answer data exceeds a threshold value.

5. The image processing apparatus according to claim 4, wherein the validity determination unit determines that the second data is not valid when the likelihood does not exceed a threshold value.

6. The image processing apparatus according to claim 4, wherein the predetermined information is at least one of three-dimensional shape information, temperature information, and motion information of the second object.

7. The image processing apparatus according to claim 1, wherein
the first data and the second data include at least one of a two-dimensional RGB image, an image having three-dimensional shape information, a stereo image, a depth image, and a monochrome image, and
the first object and the second object are faces of persons.

8. A training apparatus comprising:
at least one processor; and
at least one memory coupled to the at least one processor, the memory storing instructions that, when executed by the processor, cause the processor to act as:
an extraction unit configured to extract a third feature from third data of a third modal type, the third data including information of a third object, and extract a fourth feature from fourth data of a fourth modal type that is different from the third modal type, the fourth data including information of a fourth object, and
an update unit configured to update a third parameter corresponding to the third modal type and a fourth parameter corresponding to the fourth modal type, based on the third feature and the fourth feature, respectively, wherein
the update unit updates each of the third parameter and the fourth parameter making the third feature and the fourth feature to be similar when the third object and the fourth object are identical.

9. The training apparatus according to claim 8, wherein the update unit updates the third parameter based on intra-class similarity between the third feature and a third representative vector representing a representative feature of the third object, and inter-class similarity between the third feature and a fourth representative vector representing a representative feature of the fourth object.

10. The training apparatus according to claim 9, wherein the update unit further updates the third representative vector, based on the intra-class similarity and the inter-class similarity.

11. The training apparatus according to claim 10, wherein
the extraction unit extracts a fifth feature from the fourth data, based on the third parameter updated by the update unit, and
the update unit updates the fourth parameter, based on the intra-class similarity between the fifth feature and the fourth representative vector, and the inter-class similarity between the fifth feature and the third representative vector.

12. The training apparatus according to claim 11, wherein number of pieces of the fourth data is smaller than number of pieces of the third data.

13. The training apparatus according to claim 8, wherein
the third data is an RGB image,
the fourth data is a monochrome image and depth information, and
the third object and the fourth object are faces of persons.

14. A method comprising:
extracting a first feature from first data of a first modal type, the first data including information of a first object that is registered, and extract a second feature from second data of a second modal type that is different from the first modal type, the second data including information of a second object for matching, and
determining whether or not the first object and the second object are identical, based on the first feature and the second feature, wherein,
a neural network used in the extracting is trained to extract the first feature and the second feature to be similar when the first object and the second object are identical.

15. A non-transitory computer-readable storage medium storing instructions that, when executed by a computer, cause the computer to perform a method comprising:
extracting a first feature from first data of a first modal type, the first data including information of a first object that is registered, and extract a second feature from second data of a second modal type that is different from the first modal type, the second data including information of a second object for matching, and
determining whether or not the first object and the second object are identical, based on the first feature and the second feature, wherein,
a neural network used in the extracting is trained to extract the first feature and the second feature to be similar when the first object and the second object are identical.
